(19) United States
(12) Patent Application Publication
(10) Pub. No.: US 2007/0056361 A1
(43) Pub. Date: Mar. 15, 2007

(54) Partitioning gas tracer tests

(75) Inventors: Paul T. Imhoff, Newark, DE (US); Pei Chiu, Hockessin, DE (US)

Correspondence Address: CONNOLLY BOVE LODGE & HUTZ LLP, P.O. BOX 2207, WILMINGTON, DE, 19899-2207, US

(73) Assignee: UNIVERSITY OF DELAWARE office of the Vice Provost for Research, Newark (DE)

(21) Appl. No.: 10/580,313

(22) PCT Filed: Nov. 24, 2004
(86) PCT No.: PCT/US04/39575

§ 371 Date: Nov. 1, 2006

Related U.S. Application Data
(60) Provisional application No. 60/524,965, filed on Nov. 25, 2003.

(51) Int. Cl. G01M 19/00

(52) U.S. Cl. 73/73; 73/37

(57) ABSTRACT

The present invention relates to detection and maintenance of specific water levels. For example, a key component in the operation of almost all bioreactor landfills is the addition of water to maintain optimal moisture conditions. To determine how much water is needed and where to add it, in situ methods were generally required to measure water within solid waste. According to the present invention, transport behavior of at least two gas tracers within solid waste can advantageously be used to measure the fraction of the void space filled with water. One tracer is conservative and does not react with solids or liquids, while a second tracer partitions into the water and is separated from the conservative tracer during transport.

### CROSS REFERENCE TO RELATED APPLICATION

This application claims priority to U.S. Provisional Ser. No. 60/524,965 filed Nov. 24, 2003, the content of which is incorporated herein by reference in its entirety.

### REFERENCE TO GOVERNMENT CONTRACT

United States Environmental Protection Agency has some rights to the instant disclosure through a subcontract through the University of New Orleans (UNO) Urban Waste Management & Research Center: UNO Account No. 32-20-5188, Contract No. 99-0335-S4. The United States Department of Energy may have some rights to the instant application through a subcontract through the Yolo county Department of Public Works Contract No. DE-SC26-01NT41152.

### BACKGROUND OF THE INVENTION

1. Field of the Invention

The present invention relates generally to moisture detection and more particularly to methods and products capable of detecting moisture in applications such as landfills, biofilters or the like.

2. Description of Related Art

Landfills operated as bioreactors are designed to enhance rates of waste decomposition and methane production (Komilis, D. P.; Ham, R. K.; Stegmann, R. The effect of landfill design and operation practices on waste degradation behavior: A review. Waste Management & Research 1999, 17, 20-26). The acidogenic phase of waste decomposition is also shortened in bioreactor landfills, resulting in reduced leachable organic emissions and reduced costs for leachate treatment (Komilis, D. P.; Ham, R. K.; Stegmann, R. The effect of landfill design and operation practices on waste degradation behavior: A review. Waste Management & Research 1999, 17, 20-26). An additional benefit of rapid decomposition is that waste settlement and compaction occur over a shorter time period, which may allow landfill space to be reclaimed sooner.

A key component in the operation of almost all bioreactor landfills is the addition of water to maintain optimal moisture conditions for biodegradation of organic wastes (Reinhart, D. R.; Townsend, T. G. Landfill Bioreactor Design and Operation, Lewis Publishers: Boca Raton, pp. 3-4, 1998). Typically, leachate collected from the bottom of a landfill is recirculated to modify the moisture conditions. However, knowing how much leachate to recirculate and where to add it can be problematic. Municipal solid waste is composed of a wide variety of materials, and the common practice of adding soil cover to land-filled material each day results in significant layering and heterogeneity. This heterogeneity in turn causes water to short circuit and move preferentially in a landfill, a process that has been difficult to measure or model (Johnson, C. A.; Richner, G. A.; Vitvar, T.; Schittli, N.; Eberhard, M. Hydrological and geochemical factors affecting leachate composition in municipal solid waste incinerator bottom ash Part I: The hydrology of Landfill Lostorf, Switzerland. Journal of Contaminant Hydrology 1998, 33, 361-376; Guyonnet, D.; Didier-Guelorget, B.; Provost, G.; Feuillet, C. Accounting for water storage effects in landfill leachate modeling. Waste Management & Research 1998, 16, 285-295).

A robust technique is required to measure water within landfills for the complex conditions in these systems. Historically, methods for measuring water were borrowed from soil science, where gamma ray attenuation (neutron probe), the dielectric constant (time-domain reflectometry and capacitance sensors), electrical resistance (gypsum blocks), water pressure (tensiometer), and thermal properties (thermal conductivity probe) are measured to quantify water in the pore space. While these methods may work in soils, they typically produce measurements of dubious accuracy in landfills. One reason is that each of these methods requires that the surrounding matrix of water and solid waste have well-defined radiologic, electrical, hydrologic, or thermal properties that are invariant with time. While this constraint is easy to satisfy in most soils, it is virtually impossible to satisfy in a landfill. For example, waste settlement within a landfill will alter the average pore size and hydraulic conductivity in the vicinity of any sampling probe. Because the bulk dielectric constant of solid waste is quite sensitive to porosity (Li, R. S.; Zeiss, C. In situ moisture content measurement in MSW landfills with TDR. Environmental Engineering Science 2001, 18, 53-66), and since it is difficult to correct for such changes as settlement progresses, measurement devices that rely on the dielectric constant might yield biased results. Furthermore, the heterogeneous nature of solid waste means that the chemical composition of material next to a probe will be different depending on the probe's location. For methods that rely upon gamma attenuation or the dielectric constant, it is difficult to calibrate the instrument for an entire landfill, since the gamma ray attenuation coefficient and dielectric constant of the solid waste material vary in space. Time dependent changes in the ionic strength of water within the landfill will influence electrical resistivity measurements and may lead to biased results for measurements that rely on this property.

A second disadvantage encountered with current technologies is that they provide point measurements. If the flow and distribution of water within a landfill were uniform, then several point measurements might be adequate. However, preferential flow is common and probably a dominant process in most landfills, significantly decreasing the value of point measurements. Measurements of water in volumes that are 1-50 m³ may be significantly more valuable for landfill managers and environmental regulators.

### SUMMARY OF THE INVENTION

According to an embodiment of the present invention, there is provided a method for measuring water/moisture in applications such as landfills. Preferably at least two gas tracers are injected into a landfill. At least one tracer is nonreactive with landfill materials, while a second tracer partitions in and out of water trapped within pore space of solid waste. Chromatographic separation of the tracers occurs between the point of tracer injection and tracer extraction, inter alia, because the second partitioning tracer is retarded due to water in the landfill. The degree of tracer retardation can be used to determine the average fraction of pore space filled with water in the volume sampled by the tracer gases. This volume may be small or large depending on the location of tracer injection and extraction. According to one embodiment, the sampling volume preferably comprises all stream paths between the injection and extraction points. The partitioning gas tracer test (PGTT) should advantageously not be affected by solid waste compaction or by heterogeneity of the solid waste composition (or lack thereof).

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE FIGURES

FIG. 1 depicts an example breakthrough curve from tests to determine Henry's law constant according to the present invention.

FIG. 2 shows volumetric water content θ_{w} measured with PGTT versus gravimetrically determined θ_{w} in an embodiment of the present invention. Error bars represent error associated with uncertainty in the gas flow rate measurements as described herein.

FIG. 3 shows a change in Henry's law constant K_{H} for difluoromethane associated with the presence of three dissolved salts according to the present invention. Each line represents the effect of a single salt.

FIG. 4 shows error in water saturation S_{w} due to an error in Henry's law constant K_{H} for difluoromethane as described in the present invention.

FIG. 5 is a plan view of an aerobic bioreactor cell in accordance with the present invention. Circled regions indicate regions sampled during PGTTs #1 and #2. Locations of three vertical cores (hole #1, #2, and #3) for measuring moisture content gravimetrically are also shown.

FIG. 6 shows the change in Henry's law constant K_{H} for difluoromethane due to changes in temperature.

FIG. 7 shows helium and difluoromethane concentrations at gas sampling wells in a field tests at Yolo County, California according to the present invention.

### DETAILED DESCRIPTION OF A PREFERRED EMBODIMENT

Internal regions of landfills are typically extremely heterogeneous environments where previously, the only reliable method for measuring water was to physically remove solid waste samples and make gravimetric measurements. Because water is often the limiting factor for degradation of solid waste materials, measuring it in various regions of a landfill has become an important problem. More recently, the U.S. Environmental Protection Agency and landfill owners have shown tremendous interest in operating landfills as bioreactors, where water is added in a controlled fashion to maintain optimal moisture conditions for solid waste degradation. Because physical sampling of the waste in situ is expensive and often impractical, the partitioning gas tracer technology offers tremendous promise.

Measuring water within landfills is an important operational requirement for bioreactor landfills and in other applications as well. Existing in situ methods may be influenced by leachate composition and properties of the solid waste. The partitioning gas tracer test (PGTT) of the present invention presents a new alternative and is unexpectedly superior to prior methods. For example, as reported infra the use of PGTT results in unbiased estimates of water saturation, over the measured a wide range of saturations, for example, from 10% to 39%, in laboratory tests. PGTT is useful, for example, for measuring water within municipal solid waste landfills.

Solid waste disposed of in landfills contains large pores associated with the voids between waste components and small pores within waste components. For example, paper can be considered a porous medium, with pores on the order of microns in size. Water resides in both large voids and in small porous regions. Theoretically, PGTTs are capable of measuring water in both domains, assuming that sufficient time is allowed for the water-partitioning tracer to diffuse into and out of all water in the system and tracer detection limits are sufficiently small. More commonly, though, PGTTs may only measure the water residing in the most accessible domains of the solid waste, i.e., the larger voids.

In several recent investigations PGTTs were used to quantify the volumetric water content θ_{w} (volume of water/sample volume) or the water saturation S_{w} (volume of water/volume of pore space) in soils. See for example tests conducted in soils in laboratory columns, Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633; Brusseau, M. L.; Popovicova, J.; Silva, J. A. K. Characterizing gas-water interfacial and bulk-water partitioning for gas-phase transport of organic contaminants in unsaturated porous media. Environmental Science & Technology 1997, 31, 1645-1649; tests conducted in a large mesoscale apparatus, Nelson, N. T.; Brusseau, M. L.; Carlson, T. D.; Costanza, M. S.; Young, M. H.; Johnson, G. R.; Wierenga, P. J. A gas-phase partitioning tracer method for the in situ measurement of soil-water content. Water Resources Research 1999, 35, 3699-3707, and tests conducted at a field site, Deeds, N. E.; Pope, G. A.; Mckinney, D. C. Vadose zone characterization at a contaminated field site using partitioning interwell tracer technology. Environmental Science & Technology 1999, 33, 2745-275 1, the contents of each are incorporated herein by reference in their entireties.

For laboratory columns and mesoscale apparatus, S_{w} determined from the gas tracers were typically within 12% percent of S_{w} determined by independent measurements. No independent measurement of S_{w} is available from the field site, but measured values are generally within expected ranges. Mass recoveries of the tracers in field tests according to the present invention typically range from 57-60%, since not all gases injected into the soil are extracted. However, it is generally not necessary to sample all tracer stream paths and collect all tracer mass. Instead, it is preferably that the same stream paths be sampled for the partitioning and conservative tracers (Whitley Jr., G. A.; McKinney, D. C.; Pope, G. A.; Rouse, B. A.; Deeds, N. E. Contaminated vadose zone characterization using partitioning gas tracers. Journal of Environmental Engineering 1999, 125, 574-582, incorporated herein by reference in its entirety).

Two tracers are advantageously employed for a PGTT: a conservative tracer is preferably employed that does not partition significantly into solids or liquids within landfills, and a partitioning tracer that partitions into the bulk water found in landfills, but has minimal affinity for the gas-water phase interface or the solid waste. These tracers are preferably also nontoxic, nonbiodegradable over the time period of the PGTT, easily detectable within the gas phase, and absent from landfill gas or found at only small concentrations within the gas phase.

Several gases may serve as conservative tracers within landfills including noble gases, such as neon, helium, and argon, and perfluorinated compounds, such as sulfur hexafluoride (SF6) and carbon tetrafluoride (CF4). Each of these gases has a low affinity for water (large K_{H}) and has negligible affinity for solid waste (small K_{d}) and the gas-water phase interface. These tracers also satisfy the other constraints listed above. In some embodiments, helium may be particularly preferable.

Partitioning tracers may include (1) halogenated aliphatic compounds, such as bromochlorodifluoromethane, dibromodifluormethane, difluoromethane, and 1,1,1-trifluoroethane; (2) weakly acidic and basic gases, such as carbon dioxide and ammonia; and (3) polar organic compounds (i.e., compounds containing oxygen or nitrogen), such as ketones, aldehydes, ethers, and amines. These compounds should have relatively small affinity for mineral surfaces, soil organic matter, and the gas-water interface. Difluoromethane may be particularly preferable in some embodiments.

In accordance with the present invention, to measure the amount of water in a prescribed volume of the land-filled material or other material sought to be tested, in one embodiment, a partitioning tracer is employed that has a retardation dominated by the bulk water in the system, such that sorption onto the solid waste and the gas-water interface are negligible in comparison. A conservative tracer in accordance with the present invention preferably comprises a tracer that has very little affinity for the solid and liquid phases in the system.

In addition to measuring water/moisture in landfills and related applications, a partitioning gas tracer test according to the present invention may also be suitable for measuring water in biofilters. Biofilters are engineered porous media intended to degrade pollutants in a gas stream. Typically, water must be supplied to biofilters to maintain optimal moisture conditions for biodegradation. Just as in landfills, though, it is difficult to measure the moisture because of the heterogeneous nature of biofilter materials and the changing nature of the filter as degradation proceeds. Partitioning gas tracers are ideally suited to measure moisture under these conditions.

In accordance with the present invention, to measure the amount of water in a prescribed volume of land-filled material or other material sought to be tested, in one embodiment, a partitioning tracer is employed that has a retardation dominated by the bulk water in the system, such that sorption onto the solid waste and the gas-water interface are negligible in comparison. A conservative tracer in accordance with the present invention preferably comprises a tracer that has very little affinity for the solid and liquid phases in the system.

In addition to measuring water/moisture in landfills and related applications, a partitioning gas tracer test according to the present invention may also be suitable for measuring water in biofilters. Biofilters are engineered porous media intended to degrade pollutants in a gas stream. Typically, water must be supplied to biofilters to maintain optimal moisture conditions for biodegradation. Just as in landfills, though, it is difficult to measure the moisture because of the heterogeneous nature of biofilter materials and the changing nature of the filter as degradation proceeds. Partitioning gas tracers are ideally suited to measure moisture under these conditions.

The present invention differs from previous applications, for example, as follows:

(a) Water is measured in solid waste in the present invention, not in soil as in the prior art.
(b) Solid waste contains a lot of water tightly bound in paper, food waste, etc. Measuring water in this mixture is different from measuring water in soil and this represents yet another important difference in terms of application and/or use.
(c) Landfill temperatures can be significantly higher than temperatures of groundwater or temperatures of soils, for example, temperatures in landfills can approach up to 120 degrees Fahrenheit., or even up to 130 degrees Fahrenheit in some months and perhaps as low as say 0 degrees Fahrenheit in other months, whereas soil temperatures are typically much more predictable since underground temperatures are much more uniform, even in summer and winter months.
(d) Water within landfills is much different from water in soils. Namely, water in landfills typically possesses many dissolved salts and organics that may make application of the partitioning gas tracer technology challenging.
(e) Solid waste within landfills is decomposing and generating methane and carbon dioxide. These gases are then collected from the landfill for treatment. Thus, there is a natural generation of gas within landfills that does not exist within soils.

The present invention in one embodiment involves the application of a relatively old process for an entirely new use. According to the prior art process, multiple chemical tracers were injected into an oil reservoir and then their concentrations were measured over time at selected sampling wells in an underground formation. One chemical tracer is inert and moves with the groundwater unimpeded. Other tracers have an affinity for the oil trapped within the subsurface. These partitioning tracers partition into and out of the immobile oil and move at a slower relative speed than the inert tracer. The mean arrival times of the inert or conservative tracer and the partitioning tracers are computed at the sampling wells. This information is then used in a simple algebraic formula to compute the average fraction of the pore space filled with oil between the point of tracer injection and the sampling well. See for example, Jim, M. Q.; Delshad, M.; Dwarakanath, V.; McKinney, D. C.; Pope, G. A., Sepehrnoori, K.; Tilburg, C. E.; Partitioning tracer tests for detection, estimation, and remediation performance assessment of subsurface nonaqueous phase liquids, Water Resources Research 1995, 31 (5), 1201-1211, incorporated herein by reference in its entirety.

In addition, tracers can be injected and withdrawn from the subsurface to quantify the amount of residual oily waste in the soil, which is associated with prior contamination spills. More recently, the technology has been used by soil scientists to measure the amount of water within soils. In this case, the tracers are typically injected in the gas phase, with the conservative tracer moving with the mean gas velocity while the partitioning tracers partition into and out of immobile or slowly moving water. In this case, the tracer test is used to quantify the amount of water in the soil between the point of tracer injection and sample measurement.

In order to estimate the accuracy of partitioning tracer tests for measuring nonaqueous phase liquids in subsurface media, computational experiments were conducted in a hypothetical aquifer contaminated with nonaqueous phase liquids (Jin, M.; Butler, G. W.; Jackson, R. E.; Mariner, P. E.; Pickens, J. F.; Pope, G. A.; Brown, C. L.; McKinney, D. C. Sensitivity models and design protocol for partitioning tracer tests in alluvial aquifers. Groundwater 1997, 35, 964-972), the content of which is incorporated herein by reference in its entirety. The Jin et al. study concluded that the retardation factor should preferably be between 1.2 and 4 in order to obtain the response curve of the partitioning tracer in a reasonable sampling period, and to ensure that good separation was achieved between the conservative and partitioning tracers. Based on the above study, similar constraints can be assumed to apply for partitioning gas tracer tests for the detection of nonaqueous phase liquids in the vadose zone. See, for example, (Whitley Jr., G. A.; McKinney, D. C.; Pope, G. A.; Rouse, B. A.; Deeds, N. E. Contaminated vadose zone characterization using partitioning gas tracers. Journal of Environmental Engineering 1999, 125, 574-582), the content of which is incorporated herein by reference in its entirety.

In accordance with the present invention, certain aspects of such tests described have been adapted and modified so as to be useful in applications such as for measuring water in a landfill or in other solid waste.

### EXAMPLES

### Example 1

Given the past success of the PGTT for measuring water in soils, a laboratory investigation was conducted to measure water in municipal solid waste. Gas tracers were selected for a landfill environment, and PGTTs were conducted in municipal solid waste that was packed into laboratory columns. Tracer tests were used to quantify the utility of the technology over a range of volumetric water contents, and when the water was solute-free or a landfill leachate.

Theory of Partitioning Gas Tracer Test

Tracer Partitioning and Transport

The basic theory behind PGTT is based upon the same principle used for chromatographic separation of chemicals: the mean travel velocity of a gaseous compound along a stream path is determined by the affinity of the compound for the immobile phase contacted along that path. If a tracer is nonreactive, it travels at the velocity of the bulk gas phase. If a tracer is reactive and partitions into an immobile phase along the stream path, the mean travel velocity will be a function of the gas phase velocity, the affinity of the tracer for the immobile phase, and the amount of the immobile phase along the stream path.

Differences in the mean travel times of partitioning and conservative tracers were first used by researchers in petroleum engineering to determine the amount of residual oil within oil reservoirs (Cooke, C. E. Method of determining fluid saturations in reservoirs, U.S. Pat. No. 3,590,923, 1971; Tomich, J. F.; Dalton, R. L.; Deans, H. A.; Shallenberger, L. K. Single-well tracer method to measure residual oil saturation. Journal of Petroleum Technology February, 1973, 211-218; Tang, J. S. Interwell tracer tests to determine residual oil saturation to waterflood at Judy Creek BHL “A” Pool. Journal of Canadian Petroleum Technology 1992, 31, 61-71), the contents of which are all incorporated herein by reference in their entireties. More recently the same principles were applied by hydrologists to determine the amount of water in the vadose zone (Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633; Brusseau, M. L.; Popovicova, J.; Silva, J. A. K. Characterizing gas-water interfacial and bulk-water partitioning for gas-phase transport of organic contaminants in unsaturated porous media. Environmental Science & Technology 1997, 31, 1645-1649, each of which is incorporated herein by reference in its entirety.). In each case investigators reasoned that the retardation factor R_{f} of a chemical tracer was related to tracer partitioning and the amount of immobile liquid (oil or water) present, where

$${R}_{f} = \frac{{\overline{v}}_{c}}{{\overline{v}}_{p}} \qquad ( 1 )$$

and is the ratio of the mean travel velocity of a conservative tracer v̅_{c} to the mean travel velocity of a partitioning tracer v̅ₚ. Standard moment analysis of tracer breakthrough curves was used to determine the mean travel velocities (Ptak, T.; Schmid, G. Dual-tracer transport experiments in a physically and chemically heterogeneous porous aquifer: Effective transport parameters and spatial variability. Journal of Hydrology 1996, 183, 117-138).

If a tracer travels in the gas phase within a landfill and if linear partitioning is assumed between a tracer and the immobile phases in the system, application of conservation of mass to tracer transport results in the following expression for R_{f} (13 (Brusseau, M. L.; Popovicova, J.; Silva, J. A. K. Characterizing gas-water interfacial and bulk-water partitioning for gas-phase transport of organic contaminants in unsaturated porous media. Environmental Science & Technology 1997, 31, pps. 1645-1649)

$${R}_{f} = 1 + \frac{{S}_{w}}{( 1 - {S}_{w} ) {K}_{H}} + \frac{{ρ}_{b} {K}_{d}}{n ( 1 - {S}_{w} ) {K}_{H}} + \frac{{K}_{IA} {A}_{IA}}{n ( 1 - {S}_{w} )} \qquad ( 2 )$$

where K_{H} is the dimensionless Henry's law constant, the ratio of the concentration of the tracer in the gas phase to that in the water phase at equilibrium; ρ_{b} is the dry bulk density of the solid waste (ML⁻³); K_{d} is the sorption coefficient for the tracer onto the solid waste (M₋₁L³); n is the porosity of the system, the volume of voids per unit bulk volume; K_{IA} is the adsorption coefficient for the gas-water interface phase, the ratio of the concentration of the tracer in the gas-water interface phase to that in the gas phase at equilibrium (L); and A_{IA} is the specific surface area of the gas-water interface, the interfacial area per unit bulk volume of the system (L). For landfills a tracer may be retarded because of partitioning into water, solid waste, or the gas-water interface. If nonaqueous phase liquids are present in the landfill (e.g., motor oil, industrial solvents), partitioning into these fluid phases may also occur, although for now we neglect this possibility.

If the objective is to measure the amount of water in a prescribed volume of the land-filled material, a suitable partitioning tracer is one whose retardation is dominated by the bulk water in the system, such that sorption onto the solid waste and the gas-water interface are negligible in comparison. The ideal conservative tracer is one that has very little affinity for the solid and liquid phases in the system. For a partitioning tracer whose retardation is dominated by partitioning in the water, eq 2 can be rewritten as

$${R}_{f} = 1 + \frac{{S}_{w}}{( 1 - {S}_{w} ) {K}_{H}} \qquad ( 3 )$$

If R_{f} is determined by the tracer breakthrough curves, the water saturation can be computed from eq. 3, assuming the appropriate Henry's law constant is known for the partitioning tracer.

The Henry's law constant is a key thermodynamic property that influences a compounds fate in the environment. Depending on the nature of an organic compound, K_{H} may be a function of temperature, pH, compound hydration, compound concentration, and the presence of additional substances in the aqueous phase, e.g., organic compounds, dissolved salts, suspended solids, dissolved organic matter, or surfactants (Staudinger, J.; Roberts, P. V. A Critical review of Henry's Law constants for environmental applications. Critical Reviews in Environmental Science and Technology, 1996, 26, 205-297, incorporated herein by reference in its entirety).

Landfill leachate typically contains dissolved organic matter; inorganic macrocomponents, such as Ca, Mg, SO₄²⁺, and HCO₃⁻¹; and small amounts of xenobiotic organic compounds originating from household or industrial chemicals, such as hydrocarbons and chlorinated aliphatics (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718). The Henry's law constant for a partitioning tracer selected for a landfill environment should preferably be minimally affected by these factors for typical leachate conditions.

While a PGTT can be used to measure the water saturation, it is often difficult to obtain independent measurements of S_{w} within solid waste to evaluate its accuracy. Typically, the wet-weight moisture content of the solid waste (mass of water/wet mass of solid waste) is determined by gravimetric measurements and is used to assess moisture content (Tchobanoglous, G.; Theisen, H.; Vigil, S. Integrated Solid Waste Management, Engineering Principles and Management Issues, McGraw-Hill, Inc.: New York, pp. 69-72, 1993, incorporated herein by reference in its entirety). In a closed one-dimensional system in the laboratory, though, gas tracers can be used to measure the porosity of the solid waste as well as S_{w}. In this case the volume of the gas phase V_{g} that the tracers travel through is estimated from transport of the conservative tracer

$${V}_{g} = \frac{{Q}_{g} X}{{\overline{v}}_{c}} \qquad ( 4 )$$

where Q_{g} is the volumetric flow rate of the gas injected into the system and X is the distance between the injection and extraction points. With S_{w} determined from eq. 3, the porosity of the system can be computed

$$n = \frac{{V}_{g} / ( 1 - {S}_{w} )}{{V}_{t}} \qquad ( 5 )$$

where Vₜ is the total volume of the experimental system which is known. The volumetric water content of the solid waste can then be calculated from θ_{w}=nS_{w}. Because θ_{w} is easily determined from gravimetric measurements, a useful means of evaluating the accuracy of the PGTT under laboratory conditions is to compare θ_{w} determined from PGTT measurements with gravimetrically determined θ_{w}. Such a procedure can be used in connection with the present invention and was utilized in the instant laboratory example. In the field, though, the system is not closed and Vₜ is unknown. In this case generally only S_{w} can be determined from a PGTT.
Time Moment Analysis

A time moment analysis is typically used to determine the retardation factor from the breakthrough curves of the two tracers (Ptak, T.; Schmid, G. Dual-tracer transport experiments in a physically and chemically heterogeneous porous aquifer: Effective transport parameters and spatial variability. Journal of Hydrology 1996, 183, 117-138, incorporated herein by reference in its entirety). The nth temporal moment is defined as

$${M}_{n , t} = {\int }_{0}^{∞} {t}^{n} {C}_{g} ( x , t ) ⅆ t \qquad ( 6 )$$

where C_{g} is the gas phase concentration of the solute measured at the point of tracer extraction and t is time. The mean or effective transport velocity of a gas phase tracer is then computed from

$$\overline{v} = \frac{X}{{M}_{1 , t} / {M}_{0 , t}} \qquad ( 7 )$$

where X is the distance between the injection and extraction points. The mean velocities of the tracers differ from each other, depending on the degree to which each tracer is retarded during transport. Using the measured travel velocities for the conservative and partitioning tracers, the retardation factor for the partitioning tracer is computed from eq. 1.

### Example 2

Experimental Methods

Tracer Gas Selection

Two tracers are advantageously employed for a PGTT: a conservative tracer is preferably employed that does not partition significantly into solids or liquids within landfills, and a partitioning tracer that partitions into the bulk water found in landfills, but has minimal affinity for the gas-water phase interface or the solid waste. These tracers are preferably also nontoxic, nonbiodegradable over the time period of the PGTT, easily detectable within the gas phase, and absent from landfill gas or found at only small concentrations within the gas phase.

Several gases may serve as conservative tracers within landfills including noble gases, such as neon, helium, and argon, and perfluorinated compounds, such as sulfur hexafluoride (SF6) and carbon tetrafluoride (CF4). Each of these gases has a low affinity for water (large K_{H}) and has negligible affinity for solid waste (small K_{d}) and the gas-water phase interface. These tracers also satisfy the other constraints listed above. In the examples helium was selected as the conservative tracer gas, and its properties are shown in Table 1.

TABLE 1
Tracer gases selected for laboratory investigation.

| | | | K_{H} | Log n-Octanol/Water | Concentration |
|---|---|---|---|---|---|
| | | Molecular | at 25° C. | Partition Coefficient | In |
| Tracer | Formula | Weight | (—) | (—) | Injection Gas |
| Helium | He | 4.0 | 106^{a} | — | 1% |
| Difluoromethane | CF₂H₂ | 52.0 | 0.47^{b} | 0.21^{c} | 100 ppm |

^{a}Measured at 25° C. (Battino, W. E.; Wilcock, R. J. Low-pressure solubility of gases in liquid water. Chemical Reviews 1977, 77, 219--262)..
^{b}Measured in this study for distilled water at 22.5-24.1° C.
^{c}Measured at 25° C. (Worksafe Australia, National Industrial Chemicals Notification and Assessment Scheme, Difluoromethane, NA/563, Sydney, Australia, 1988).

Hydrologists measuring water in the vadose zone have used carbon dioxide (Brusseau, M. L.; Popovicova, J.; Silva, J. A. K. Characterizing gas-water interfacial and bulk-water partitioning for gas-phase transport of organic contaminants in unsaturated porous media. Environmental Science & Technology 1997, 31, 1645-1649), bromochlorodifluoromethane (Deeds, N. E.; Pope, G. A.; Mckinney, D. C. Vadose zone characterization at a contaminated field site using partitioning interwell tracer technology. Environmental Science & Technology 1999, 33, 2745-2751), dibromodifluormethane (Nelson, N. T.; Brusseau, M. L.; Carlson, T. D.; Costanza, M. S.; Young, M. H.; Johnson, G. R.; Wierenga, P. J. A gas-phase partitioning tracer method for the in situ measurement of soil-water content. Water Resources Research 1999, 35, 3699-3707), and difluoromethane (Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633) as partitioning tracers. Partitioning tracers may include (1) halogenated aliphatic compounds, such as bromochlorodifluoromethane, dibromodifluormethane, difluoromethane, and 1,1,1-trifluoroethane; (2) weakly acidic and basic gases, such as carbon dioxide and ammonia; and (3) polar organic compounds (i.e., compounds containing oxygen or nitrogen), such as ketones, aldehydes, ethers, and amines. These compounds should have relatively small affinity for mineral surfaces, soil organic matter, and the gas-water interface. Difluoromethane was used in the experiments because it appears to be the most suitable of the above partitioning tracers for landfill applications. Bromochlorodifluoromethane and dibromodifluormethane were not chosen because they might be reductively dehalogenated by anaerobic microorganisms such as methanogens and sulfate reducers, as has been observed for other chlorinated and brominated aliphatics (Belay, N.; Daniels, L. Production of ethane, ethylene, and acetylene from halogenated hydrocarbons by methanogenic bacteria. Applied Environmental Microbiology 1987, 53, 1604-1610; Sonier, D. N. ; Duran, N. L.; Smith, G. B. Dechlorination of trichlorofluoromethane (CFC-11) by sulfate-reducing bacteria from an aquifer contaminated with halogenated aliphatic compounds. Applied Environmental Microbiology 1994, 60, 4567-4572). In contrast, fluorinated compounds such as difluoromethane are less likely to undergo reductive dehalogenation reactions due to the high carbon-fluorine bond energies (Key, B. D.; Howell, R. D.; Criddle, C. S. Fluorinated organics in the biosphere. Environmental Science & Technology 1997, 31, 2445-2454). Direct reductive defluorination is difficult and is rarely observed (Key, B. D.; Howell, R. D.; Criddle, C. S. Fluorinated organics in the biosphere. Environmental Science & Technology 1997. 31, 2445-2454; Visscher, P. T.; Culbertson, C. W.; Oremland, R. S. Degradation of trifluoroacetate in oxic and anoxic sediments. Nature 1994, 369, 729-731). Indirect defluorination, which occurs via reductive dechlorination or debromination followed by β- or α-elimination and hydrolysis to remove fluoride, is more common (Krone, U. E.; Thauer, R. K. Dehalogenation of Trichlorofluoromethane (CFC-11) by Methanosarcina barkeri. FEMS Microbiological Letters 1992, 90, 201-204; Krone, U. E.; Thauer, R. K.; Hogenkamp, H. P. C.; Steinbach, K. Reductive formation of carbon monoxide from CCl₄ and freons 11, 12, and 13 catalyzed by corrinoids. Biochemistry 1991, 30, 2713-2719; Gorsky, B. H. ; Cascorbi, H. F. Halothane hepatotoxicity and fluoride production in mice and rats. Anesthesiology 1979, 50, 123-125). However, indirect reductive defluorination is not possible for difluoromethane since the reaction requires the presence of a chlorine or bromine substituent on the same or an adjacent carbon atom (Krone, U. E.; Thauer, R. K.; Hogenkamp, H. P. C.; Steinbach, K. Reductive formation of carbon monoxide from CCl₄ and freons 11, 12, and 13 catalyzed by corrinoids. Biochemistry 1991, 30, 2713-2719), which is lacking in difluoromethane. Other reactions difluoromethane may undergo, such as oxidative degradation by hydroxyl radical (Key, B. D.; Howell, R. D.; Criddle, C. S. Fluorinated organics in the biosphere. Environmental Science & Technology 1997, 31, 2445-2454; Franklin, J. The Atmospheric Degradation and Impact of 1,1,1,2-Tetrafluoroethane (Hydrofluorocarbon 134a). Chemosphere 1993, 27, 1565-1601) or monooxygenase enzymes (Olson, M. J.; O'Gara, J. F.; Surbrook, S. E. Jr. Metabolism in vivo and in vitro of the refrigerant substitute 1,1,1,2-tetrafluoro-2-chloroethane. Drug Metabolism and Disposition 1991, 19, 1004-1011), are most likely insignificant in landfills. The inertness of difluoromethane, combined with its high affinity for water (due to the strong electronegativity of the fluorine substituents), makes it a suitable partitioning tracer for landfill applications.

Difluoromethane is a refrigerant gas and is used in low temperature refrigeration units, such as air conditioners and industrial cooling processes (Worksafe Australia, National Industrial Chemicals Notification and Assessment Scheme, Difluoromethane, NA/563, Sydney, Austrialia, 1998). It has been introduced to replace ozone-depleting chlorofluorocarbons and has negligible ozone depleting potential. The properties are difluoromethane are shown in Table 1 above.

Measurement of Henry's Law Constant

The Henry's law constant for helium is well known and is reported in Table 1 above. While the influence of temperature and leachate composition will have some effect on K_{H}, because K_{H}≈100 small changes in the Henry's law constant should have a minimal impact on helium transport: helium has such a strong affinity for the gas phase, that partitioning into the water phase will have a negligible influence on helium's mean travel velocity.

### Example 3

The Henry's law constant for difluoromethane in clean water was determined to be K_{H}=0.59 in a recent experimental study (Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633). Based on the chemical structure of difluoromethane and the ranges of chemical parameters for landfill leachate reported in a recent review (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718), leachate composition should typically not have a significant influence on difluoromethane partitioning. Experiments were conducted to determine K_{H} for distilled water and a landfill leachate collected from the Cherry Island Landfill in Wilmington, Del. The composition of this test leachate is shown in Table 2. The leachate was kept in an oxygen-free environment before the K_{H} measurements.

TABLE 2
Composition of landfill leachate.

| Parameter | Value |
|---|---|
| pH | 8.14 |
| Specific conductivity (μS cm⁻¹) | 7,770 |
| Total suspended solids (mg/l) | 403 |
| Total dissolved solids (mg/l) | 4,190 |
| Total organic carbon, TOC (mg/l) | 265 |
| Biological oxygen demand, BOD₅ (mg/l) | 68 |
| Chemical oxygen demand, COD (mg/l) | 963 |

The experimental procedure used to determine K_{H} was similar to that reported in an earlier study (Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633). A jacketed glass column 60-cm long and 5-cm in diameter (Ace Glass, Inc., Vineland, N.J.) was packed with 50/70 silica sand (d₅₀=0.26 mm, uniformity index=1.186; U.S. Silica, Ill.) underwater using distilled water. The column was positioned vertically, and suction was applied to the bottom of the column to drain water from the porous medium. Gravimetric measurements were then used to determine the porosity of the sand column and the final water saturation of the system. This packing procedure ensured that the water was uniformly distributed in the porous medium.

A water bath and pump were used to recirculate water in the glass jacket surrounding the porous medium to maintain fluid and gas temperatures between 22.5-24.1° C. during the experiments. Each gas tracer test was started by directing a gas mixture, helium and difluoromethane in a balance of nitrogen, from a compressed gas cylinder into the sand column. The tracer gases were introduced as a step-input into the porous medium. A low-flow mass flow controller (Model VCD 1000, Porter Instruments, Hatfield, Pa.) was used to maintain a constant mass flux through the column during each experiment. The gas leaving the column was sampled using a 1-ml gas sampling valve at time intervals that varied depending on the gas flow rate for each experiment. Tracer concentrations in the gas samples were quantified with a gas chromatograph (Model 8610C, SRI Instruments, Torrance, Calif.): tracers were separated using mol-sieve and silica gel packed columns and then detected with a thermal conductivity (helium) or flame ionization detector (difluoromethane). Each experiment was stopped when the tracer concentrations in the effluent from the porous medium equaled the influent concentrations. To eliminate any concern about the influence of mass transfer limitations on K_{H} measurements, six trials were conducted over a wide range of gas velocities to assess whether gas velocity affected the measurements.

Three trials were performed to determine K_{H} for the leachate. The experimental procedures were modified slightly from those described above for distilled water. Here, the column was packed with dry sand, purged with nitrogen, and the leachate was flushed upward in the vertically-mounted column to displace the gas. Nitrogen was then injected into the top of the column to force the mobile water out of the column. This procedure allowed the column to be wetted with the leachate while under anaerobic conditions. Between experimental trials anaerobic conditions were maintained in the column to minimize reactions within the leachate that might alter its composition. The temperatures for the leachate tests ranged between 25.5-26.0° C.

The Henry's law constant was determined in each of the above tests using the tracer breakthrough curves and the known porosity and water saturation for the porous medium. Time moment analysis was used to determine the mean tracer velocities; R_{f} was computed from eq. 1; and using known n and S_{w}, K_{H} was computed from eq. 3.

### Example 4

Water Measurements in Municipal Solid Waste

Five experiments were conducted to measure the volumetric water content of solid waste. Four different solid waste compositions were used for the experiments and are shown in Table 3.

TABLE 3
Composition and properties of experimental packings. Solid waste constituents are
percent by mass.

| Constituent | Packing #1 | Packing #1 | Packing #2 | Packing #3 | Packing #4 |
|---|---|---|---|---|---|
| or Property | (Exp. 1) | (Exp. 2) | (Exp. 3) | (Exp. 4) | (Exp. 5) |
| Yardwaste | 19.2 | 19.2 | 23.2 | 20.0 | 2.0 |
| Foodwaste | 25.8 | 25.8 | 29.4 | 42.9 | 0.0 |
| Paper | 39.4 | 39.4 | 15.8 | 0.0 | 16.0 |
| Plastic | 11.2 | 11.2 | 18.0 | 22.8 | 0.0 |
| Glass | 4.3 | 4.3 | 13.5 | 14.3 | 82.0 |
| Bulk Density, dry | 0.35 | 0.28 | 0.26 | 0.28 | 0.43 |
| (g/cm³) | | | | | |
| Porosity^{a}, n (—) | 0.80-0.82 | 0.82-0.91 | 0.69-0.78 | 0.78-0.84 | 0.67-0.69 |
| Volumetric Water | 0.31 | 0.19 | 0.18 | 0.10 | 0.06 |
| Content, θ_{w} (—) | | | | | |
| Water Saturation^{a}, | 0.37-0.39 | 0.20-0.23 | 0.24-0.27 | 0.12-0.13 | 0.09 |
| S_{w} (—) | | | | | |
| Moisture Content, | NA | 0.51 | 0.56 | 0.39 | 0.14 |
| M_{c} | | | | | |

^{a}Measured by gas tracer tests.
NA = not available

The composition of packing #1 was selected to mimic the average composition of trash found in municipal solid waste landfills in Delaware (SCS Engineers, Delaware Solid Waste Authority Characterization Study, 1997). The solid waste compositions of the remaining packings were altered to enable a wider range of θ_{w} for the experiments: the amount of paper, foodwaste, and yardwaste had a significant influence on θ_{w} for each packing.

The preparation of the solid waste was the same for all experiments. The solid waste components were cut or broken into small pieces and then soaked in a known mass of water. The waste was removed from the soaking solution, mechanically squeezed, and packed into the same glass column used for the K_{H} measurements. Gravimetric measurements of the soaking solution before the solid waste was added and after it was removed, and the weight of the water that was drained from the solid waste through mechanical squeezing were used to determine θ_{w} of the packed column. These measurements only accounted for the water that was added to the solid waste: water that was initially bound to the air-dry waste material was not included.

The wet-weight moisture content of the solid waste M_{c} (mass of water/wet mass of solid waste) was determined in experiments 2-5. After completing the PGTT tests, the solid waste was removed from the column, weighed, oven dried at 105.0±1.0° C. for 24 h, and then weighed again. Combining these measurements with the gravimetric measurements described above, the moisture content of the solid waste was determined before water addition (initial M_{c}) and after the solid waste was packed into the column (final M_{c}).

The volumetric water contents and final moisture contents for each experiment are reported in Table 3 above. Volumetric water contents vary between experiments primarily because of the amount of liquid water retained by each packing, not because of the initial moisture associated with the air-dry waste. Dry bulk densities of the air-dry waste determined before water addition are also shown. These bulk densities are representative of lightly compacted solid waste, as they are somewhat smaller than bulk densities reported for normally compacted municipal waste in landfills (Tchobanoglous, G.; Theisen, H.; Vigil, S. Integrated Solid Waste Management, Engineering Principles and Management Issues, McGraw-Hill, Inc.: New York, pp. 69-72 1993): 0.36-0.50 g/cm³, the content of which is incorporated herein by reference in its entirety.

After packing each column, two or three PGTT measurements were made in each experiment following the same procedures described above for the K_{H} measurements. Time moment analyses were performed to determine mean tracer travel times, from which S_{w} (eq. 3) and n (eq. 5) were determined. Because only θ_{w} was determined through gravimetric measurements, for comparison purposes θ_{w} was computed from the PGTT measurements using θ_{w}=nS_{w}.

Henry's Law Constant

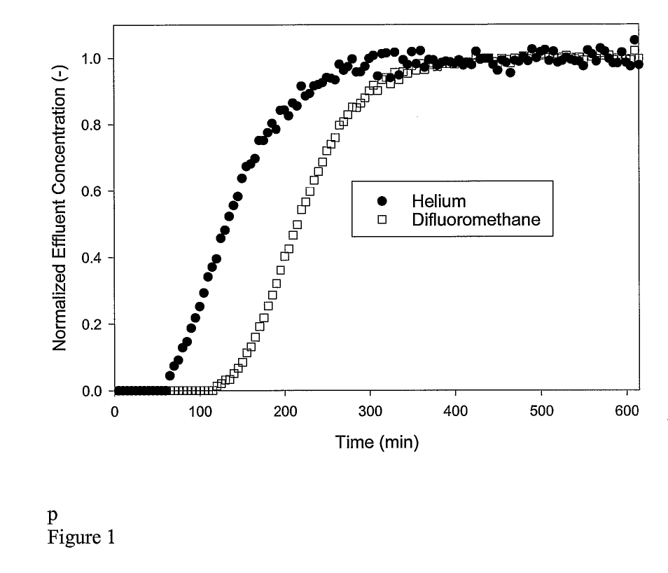

The porosity and water saturation of the sand column used in the measurements for K_{H} were n=0.34 and S_{w}=0.24 respectively. FIG. 1 shows a typical breakthrough curve from the six PGTTs in a representative system with distilled water. Helium breaks through much earlier than difluoromethane, although both tracers eventually reach the injection concentration at late time. Using data from the six trials and following the analysis procedures outlined above, the Henry's law constant for difluoromethane was K_{H}=0.47±0.07 CI (CI=95% confidence interval). Although the interstitial gas velocity was varied from 2.1 m/day to 46.9 m/day in the six trials, there were no systematic changes in K_{H} as gas velocity increased. For this reason, it is unlikely that mass transfer limitations affected K_{H} measurements.

### Example 5

Three PGTT were conducted with landfill leachate to explore the influence of leachate composition on difluoromethane partitioning. The porosity and leachate saturation of the sand column were n=0.41 and S_{w}=0.17 respectively, while the average interstitial gas velocity used in the tracer tests was 25.2 m/day. The Henry's law constant for difluoromethane was K_{H}=0.57±0.09 CI, which is 20% larger than that for distilled water. The increase in K_{H} may have been due to constituents in the leachate or temperature differences between K_{H} measurements in leachate and distilled water: mean leachate temperatures were approximately 2.5° C. larger than those for distilled water. In the measurements reported below for solid waste the Henry's law constant for difluoromethane was assumed to be K_{H}=0.47, since distilled water was added to the solid waste to achieve different water contents. The impact of leachate composition and temperature on the Henry's law constant and their influence on field measurements is discussed further below.

### Example 6

Water Saturation in Municipal Solid Waste

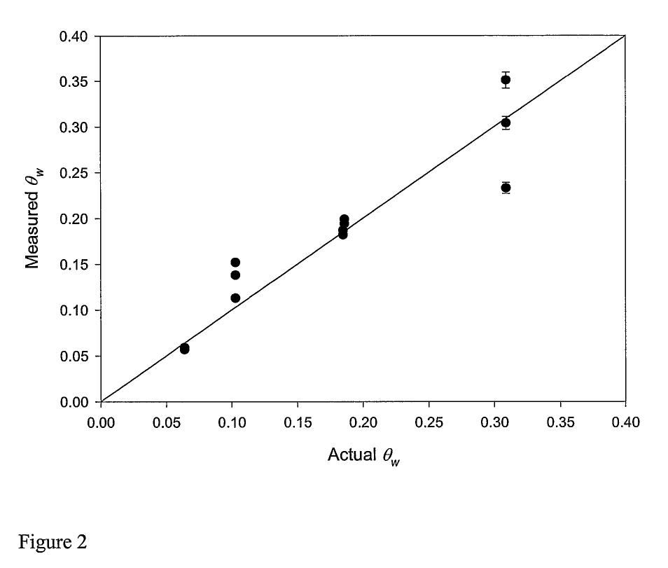

Five experiments were conducted in four different solid waste packings to evaluate the utility of PGTT for measuring water. The results from these experiments are shown in FIG. 2, where θ_{w} measured with PGTT are plotted versus gravimetric measurements. Volumetric water contents were determined over a wide range, θ_{w}=0.06 to θ_{w}=0.31, representing water saturations that ranged from S_{w}=0.09 to S_{w}=0.39. These water contents and water saturations were determined from measured water added to the air-dry waste; they do not account for the additional water contained within the waste components before liquid water addition. The initial moisture content of the solid waste in these experiments ranged from 0.1% (experiment 5) to 18.3% (experiment 2), while the final moisture content after adding water to the solid waste ranged from 14.5% (experiment 5) to 56.0% (experiment 3).

Errors in θ_{w} measurements using PGTT were at most 48%, with most less than 15%. There was no systematic bias in the measurements: the data fell evenly about the line of perfect fit shown in FIG. 2. Thus, these PGTTs measured the free liquid water added to the air-dry waste with reasonable accuracy. On the other hand, the variation in measured θ_{w} for replicate tests for the same experiment was more significant than expected, and may be due to the relatively large interstitial gas velocities used in these experiments, which ranged from 6 to 39 m/day. While we observed no systematic errors associated with changes in gas velocity over this range in the K_{H} measurements, others measuring water in soils suggest that gas velocities be kept to less than approximately 1 m/day to minimize errors associated with mass transfer limitations (Deeds, N. E.; McKinney, D. C.; Pope, G. A.; Whitely Jr., G. A. Difluoromethane as partitioning tracer to estimate vadose water saturations. Journal of Environmental Engineering 1999, 125, 630-633). The precision of water measurements may be improved if smaller gas velocities were used. Despite the significance of the random errors in these data, the results are encouraging and demonstrate that the PGTT is a promising technology for measuring water in solid waste.

Factors Affecting Henry's Law Constant

The Henry's law constant of the partitioning tracer is a critical parameter in the measurement of water with a PGTT. While the effect of leachate composition and a small temperature change (2.5° C.) had a minor effect on K_{H} for the test leachate in these examples reported herein, there may be other factors that might influence difluoromethane partitioning. A comprehensive critical review of Henry's law constants for organic compounds suggests that two of the most important factors that may influence difluoromethane partitioning into leachate are dissolved salts and temperature (Staudinger, J.; Roberts, P. V. A Critical review of Henry's Law constants for environmental applications. Critical Reviews in Environmental Science and Technology, 1996, 26, 205-297, the content of which is incorporated herein by reference in its entirety). Other factors, such as dissolved organic matter and suspended solids are important for hydrophobic compounds (high octanol/water partition coefficient), but should be of minor importance for difluoromethane.

Dissolved inorganic salts affect the fugacity of a compound in the water phase, but do not influence the fugacity in the gas phase. Therefore, we estimated the influence of dissolved salts on difluoromethane partitioning by estimating their effect on its water solubility, using a modified Setschenow equation (Schwarzenbach, R. P.; Gschwend, P. M.; Imboden, D. M. Environmental Organic Chemistry, John Wiley & Sons: New York, pp. 93-96, 1993)
K_{H,salt}=K_{H}×10^{K}^{ₛ}^{[salt]} (8)
where K_{H} and K_{H,salt} are Henry's law constants for pure water and water containing dissolved salts, respectively, and K_{S} is the Setschenow constant or salting constant, in M⁻¹. The salt effect is compound-dependent and somewhat affected by the ionic species present in solution (Schwarzenbach, R. P.; Gschwend, P. M.; Imboden, D. M. Environmental Organic Chemistry, John Wiley & Sons: New York, pp. 93-96, 1993). The Setschenow constant for difluoromethane is generally thought to be unknown, a conservative K_{S} value of 0.3 was employed, the largest value reported for halogenated aliphatic compounds in seawater (Schwarzenbach, R. P.; Gschwend, P. M.; Imboden, D. M. Environmental Organic Chemistry, John Wiley & Sons: New York, pp. 93-96, 1993). Because the composition of ionic species in landfill leachate vary widely (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718), we performed the calculation for three salts consisting of mono- and di-valent ions commonly found in leachate (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718). To simplify the analysis, it was assumed that only a single salt was in the leachate at any time. A wide range of salt concentrations were examined to bracket the observed range of electrical conductivities for leachate (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718). The salt concentrations for the Setschenow equation were obtained at a specified electrical conductivity for the leachate using (Tchobanoglous, G.; Schroeder, E. D. Water Quality, Addison-Wesley: Reading, Mass., pp. 91-92, 1987)

$$EC \approx {\sum }_{i} ( {C}_{i} \times {f}_{i} ) \qquad ( 9 )$$

where EC is electrical conductivity in μS/cm, Cᵢ is ion concentration in meq/L, and fᵢ is the conductivity factor in μS-L/cm-meq. The fᵢ values for Na⁺, K⁺, Mg²⁺, Cl⁻, and SO₄²⁻ are 48.9, 72.0, 46.6, 75.9, and 73.9, respectively (Tchobanoglous, G.; Schroeder, E. D. Water Quality, Addison-Wesley: Reading, Mass., pp. 91-92, 1987).

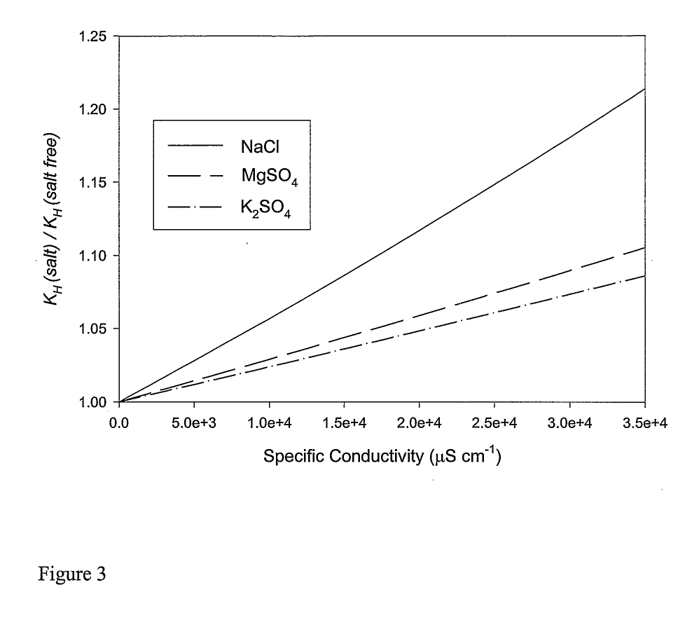

FIG. 3 shows the salt effect on the Henry's law constant for difluoromethane when the salt is NaCl, MgSO₄, or K₂SO₄. The salt effect is largest for NaCl, although the change in K_{H} is less than 20% even for the highest leachate conductivity reported (Christensen, T. H.; Kjeldsen, P.; Bjerg, P. L.; Jensen, D. L.; Christensen, J. B.; Baun, A.; Albrechtsen, H.-J.; Heron, G. Biogeochemistry of landfill leachate plumes. Applied Geochemistry 2001, 16, 659-718). Calculations expressed herein reflect that all conductivity was attributed to a single salt (NaCl, MgSO₄, or K₂SO₄), and as such, the change in Henry's law constant for an actual leachate with a given conductivity should fall between those reported for NaCl and K₂SO₄ in FIG. 3.

Temperature is also expected to influence difluoromethane partitioning into water. The solid waste experiments in this study were conducted between 25.5-26.3° C., while landfill temperatures may vary between 10-60° C., depending on climatic conditions and landfill properties. While the temperature dependence of Henry's law constant for difluoromethane has not been reported, changes in partitioning with temperature were reported for a similar compound, fluoromethane (Staudinger, J.; Roberts, P. V. A critical compilation of Henry's law constant temperature dependence relations for organic compounds in dilute aqueous solutions. Chemosphere 2001, 44, 561-576). Here, K_{H} increased by approximately 20% for every 10° C. increase in temperature, and similar variations are expected for difluoromethane. Fortunately, temperature can easily be measured in landfill regions where PGTTs are conducted. If the temperature dependence of K_{H} for difluoromethane is determined in future research, corrections may then be used to account for the effect of temperature on difluoromethane partitioning in field tests.

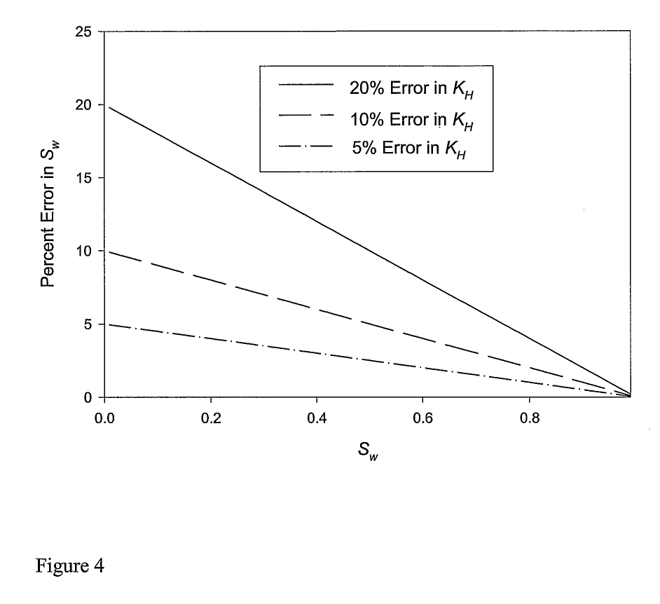

It is important to evaluate the influence of errors in K_{H} associated with dissolved salts or temperature on water saturation measurements. A propagation of error analysis was used to determine the systematic bias in S_{w} due to a systematic error in K_{H}, and the results are shown in FIG. 4. Relative errors in S_{w} are always less than or equal to relative errors in K_{H}, with errors in S_{w} decreasing as water saturation increases. Since for difluoromethane the error in K_{H} due to dissolved salts is expected to be less than 20%, errors in S_{w} should also be 20% or less. The effect of temperature on difluoromethane partitioning is less certain. However, if the error in K_{H} for difluoromethane is similar to that of fluoromethane and if temperature variations on the order of 10° C. are not accounted for in field measurements, errors in K_{H} are also expected to be on the order of 20%, resulting in S_{w} errors of 20% or less. These results suggest that both dissolved salts and temperature will contribute to water saturation measurement errors on the order of 20% or less. More accurate measurements can be achieved if the leachate has moderate to low salinity, and if the temperature that the PGTT is conducted at in the field is measured and used to select the appropriate K_{H}.

Moisture Content Versus Volumetric Water Content or Water Saturation

Moisture content is the most common measurement of water within the solid waste industry. One reason this measure is so frequently used is that it is simple and only involves gravimetric measurements. On the other hand, PGTTs determine the water saturation for open systems in the field, or both the water saturation and the volumetric water content for closed systems in the laboratory. How PGTTs determine with reasonable accuracy the volumetric water content associated with liquid water added to air-dry waste has been demonstrated. While it may be possible for PGTTs to determine all water contained within the pores of solid waste, the instant tests determined the liquid water that was added to the waste. Water contained in the initial air-dry waste was not measured.

While moisture content will in general increase with increasing water saturation, see for example the data shown in Table 3 above, it may be impossible to establish a quantitative relationship between the two. Because the moisture content is a gravimetric measurement, it is dependent on the volume of water in the solid waste sample, the density of solid waste components, and the gas-filled volume of the sample. On the other hand, water saturation is a function of the volume of water and the gas-filled volume of the sample. While approximate relationships may be developed to relate moisture content and water saturation for specific types of solid waste, it is unlikely that quantitative relationships can be found.

Partitioning gas tracer tests are a promising technology for measuring water within landfills. Changes in landfill properties have a minor influence on this technology (e.g., porosity, leachate salinity), and PGTTs are capable of measuring the water saturation in small or large volumes of solid waste, depending on the position of the tracer injection and extraction points. Such tests are useful to determine relative differences in moisture in various regions of a landfill, thus enabling operators to determine where to add additional water.

### Example 7

Partitioning gas tracer tests (PGTT) conducted in laboratory columns packed with solid waste are described above with water saturations ranges from 0.09 to 0.39. Because of the success of that work, field tests were conducted to evaluate the utility of PGTT for measuring water in an actual landfill. These results along with additional laboratory tests necessary to quantify the Henry's law constant for the instant partitioning tracer under field conditions are shown below

Laboratory and Field Tests: Methodology

Difluoromethane was selected as the partitioning tracer, which partitions into water within the solid waste, while helium was selected as the conservative tracer. A key thermodynamic parameter necessary for interpretation of data from a PGTT is the Henry's law constant of the partitioning tracer. Laboratory tests were conducted in batch systems to determine the Henry's law constant for difluoromethane from 4° C. to 50° C., which covers the temperature range observed in our field tests. In addition, batch experiments were also conducted with filter paper wetted to different degrees to assess the ability of PGTT to measure water in small pores and sorbed to solid surfaces.

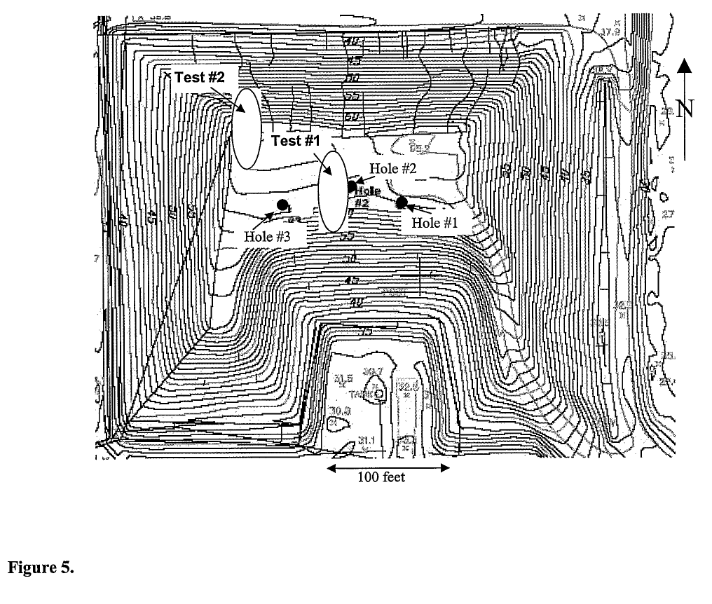

The southeast aerobic bioreactor test cell at the Yolo County, California landfill is highly instrumented and is an ideal location to test this new technology. Two PGTTs were conducted, and the results from these tests compared with moisture contents determined from solid waste cores removed from the aerobic bioreactor. The two field tests were conducted in different regions of the aerobic bioreactor landfill and measured water in ˜250 ft³ of solid waste. The tracer gas (99% helium and 1% difluoromethane) (in some embodiments of the invention the contents can range, for example from 80-99% helium and from 1-20% difluormethane) was injected at 39.4 L/min through pre-installed monitoring wells: 1-13-SE for Test #1, and 2-1-SE for Test #2. Gases were extracted in nearby horizontal gas collection lines, and this gas stream was sampled periodically to determine concentrations of the tracer gases through time. Tracer concentrations were determined using a field-portable gas chromatograph equipped with a flame ionization detector and a thermal conductivity detector for measurement of difluoromethane and helium, respectively. The locations of the both tracer tests is shown below in FIG. 5. Both tests sampled solid waste located 10′-17.5′ below the topmost surface of the landfill

Laboratory and Field Tests: Results

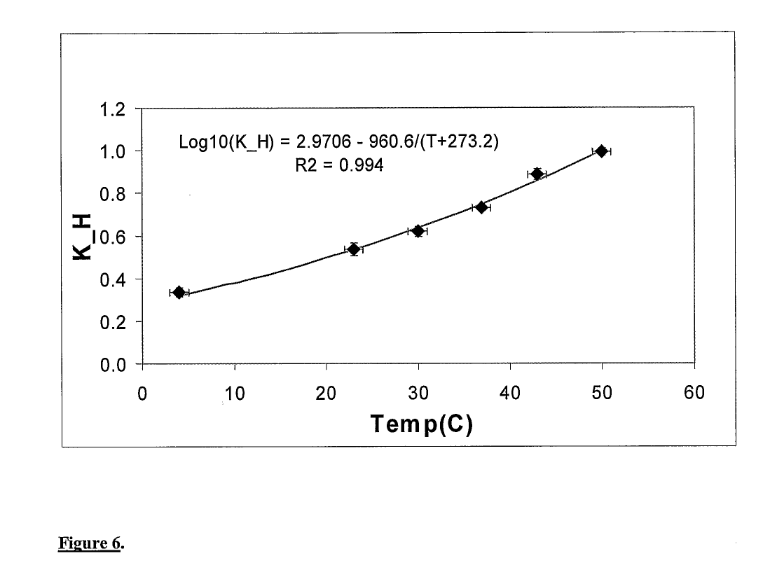

In laboratory tests, the Henry's law constant for difluoromethane changed significantly with temperature, increasing logarithmically from 0.34 at 4° C. to 0.99 at 50° C., as shown in FIG. 6. Thus, landfill temperatures in the region of a PGTT must be measured in order to select the appropriate Henry's law constant for interpretation of PGTT data. Tests with filter paper wetted by different amounts indicated that difluoromethane is capable of “measuring” essentially all water contained in the fine pores of paper. However, difluoromethane is incapable of accurately determining the water sorbed to paper fibers.

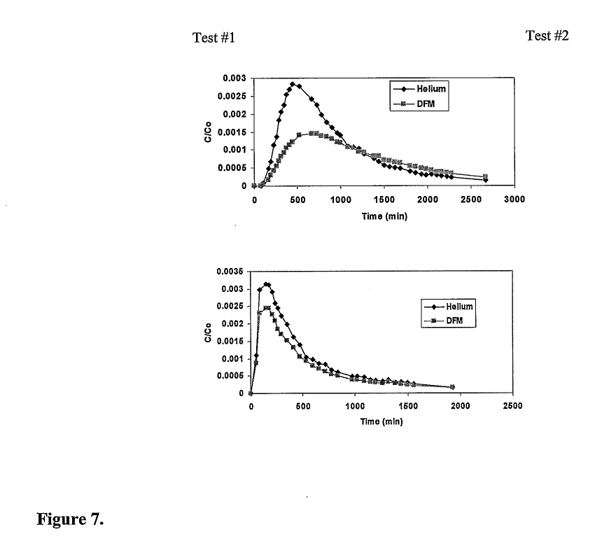

Field tests in the aerobic bioreactor landfill at Yolo County were conducted. The tracer breakthrough curves at the gas collection wellhead measured for Tests #1 and #2 are shown in FIG. 7. In the center of the landfill (Test #1 in FIG. 5), PGTT measurements indicated that the fraction of the pore space filled with water was 29%, while the moisture content, the mass of water divided by total wet mass of solid waste, was 28%. The moisture content, which is not directly measured by PGTT, was estimated using the measured water saturation and estimates for the waste porosity and bulk density. Near the sloped sides of the landfill, PGTT results indicated that only 7.1% of the pore space was filled with water (Test #2 in FIG. 5), while the moisture content was estimated to be 6.9%. These measurements are in close agreement with gravimetric measurements made on solid waste samples collected after each PGTT: moisture content of 27% in the center of the landfill (hole #1 in FIG. 6) and only 6% near the edge of the landfill (hole #3 in FIG. 5). While the gravimetric measurement from hole #3 is located some distance from the PGTT for Test #2, Test #2 is most similar in location to hole #3, which is also located on the edge of the landfill.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

As used herein and in the following claims, articles such as “the”, “a” and “an” can connote the singular or plural.

The term “solid waste” as used herein means material in a landfill or other area where unused material is placed for purposes of decomposition.

What is claimed is:

1. A method for determining targeted water content in a predetermined environment comprising:
measuring water within solid waste by injecting at least two gas tracers within solid waste to measure a fraction of void space filled with water, and
determining an amount of water to be added to said environment, wherein one of said gas tracers is conservative and does not react with solids or liquids, and a second gas tracer partitions into the water and is separated from the conservative tracer during at least a portion of said method.

2. A method of claim 1 wherein said tracers comprise helium and difluoromethane.

3. A method of claim 1, wherein said tracers are injected and chromatographic separation of the tracers is measured between a point of tracer injection and a point of tracer extraction such that the degree that the second partitioning tracer is retarded correlates to the average water saturation in the environment.

4. A method of claim 1, wherein said conservative tracer comprises at least one noble gas or one perfluorinated compound.

5. A method of claim 4, wherein said conservative tracer is selected from the group consisting of neon, helium, argon, and perfluorinated compounds.

6. A method of claim 5, wherein each of said conservative tracers has a low affinity for water (K_{H}) and has negligible affinity for solid waste (K_{d}) and a gas-water phase interface.

7. A system comprising
at least two tracers comprising:
(i) a conservative tracer is that does not partition significantly into solids or liquids within landfills, and
(ii) a partitioning tracer that partitions into bulk water, but has minimal affinity for a gas-water phase interface or for solid waste, and
a chromatograph capable of measuring separation of said at least two tracers after said tracers have been injected into a material.

8. A system according to claim 7, wherein each of said tracers are nontoxic, nonbiodegradable, and detectable within a gas phase.

9. A system according to claim 7, wherein said tracers are absent from landfill gas and/or found at negligible concentrations within said gas phase.

10. A method of claim 1, wherein said partitioning tracer comprises at least at least one of (1) halogenated aliphatic compounds, (2) weakly acidic and basic gases, and (3) polar organic compounds.

11. A method of claim 1, wherein said partitioning tracer is employed that has a retardation dominated by bulk water in the environment, such that sorption onto solid waste and a gas-water interface are negligible in comparison, and wherein said conservative tracer has minimal affinity for solid and liquid phases in the environment.

12. A method suitable for measuring water in a biofilter, said biofilter being engineered porous media intended to degrade pollutants in a gas stream, said method comprising
injecting at least two gas tracers within said biofilter to measure a fraction of void space filled with water, and
determining an amount of water to be added to said biofilter wherein one of said gas tracers is conservative and does not react with solids or liquids, and a second gas tracer partitions into the water and is separated from the conservative tracer during at least a portion of said method.

13. A method of claim 12 wherein said water is supplied to said biofilter to maintain optimal moisture conditions for biodegradation.

14. A tracer kit comprising at least two tracers comprising
(i) a conservative tracer that does not partition significantly into solids or liquids within landfills, and
(ii) a partitioning tracer that partitions into bulk water found in landfills, but has minimal affinity for gas-water phase interface or for solid waste.

15. A kit of claim 14, wherein said tracers are nontoxic, nonbiodegradable over a predetermined time period, not easily detectable within the gas phase, and/or absent from landfill gas and/or found at only small concentrations within the gas phase.

16. A kit of claim 14, wherein said conservative tracer comprises at least one noble gas and/or one perfluorinated compound.

17. A kit of claim 14, wherein each of said tracers has a low affinity for water (K_{H}) and has negligible affinity for solid waste (K_{d}) and a gas-water phase interface.

18. A kit of claim 14, wherein said partitioning tracer comprises at least one of (1) halogenated aliphatic compounds, (2) weakly acidic and basic gases, and (3) polar organic compounds.
